(19) United States
(12) Patent Application Publication
(10) Pub. No.: US 2022/0322180 A1
(43) Pub. Date: Oct. 6, 2022

(54) PHYSICAL UPLINK CONTROL CHANNEL (PUCCH) REPETITION COUNTING DURING DUAL ACTIVE PROTOCOL STACK (DAPS) HANDOVER (HO)

(71) Applicant: QUALCOMM Incorporated, San Diego, CA (US)

(72) Inventor: Hung Dinh LY, San Diego, CA (US)

(21) Appl. No.: 17/222,890

(22) Filed: Apr. 5, 2021

(51) Int. Cl. H04W 36/08; H04L 5/14; H04W 72/04

(52) U.S. Cl. CPC H04W 36/08; H04L 5/14; H04W 72/0413; H04W 72/0446

(57) ABSTRACT

Aspects of the present disclosure includes methods for transmitting to a source base station associated with a source master cell group (MCG), a physical uplink control channel (PUCCH) repetition in each of one or more slots of the source MCG during a dual active protocol stack (DAPS)-based handover of the UE from the source MCG to a target MCG. The method includes transmitting, to a target base station associated with the target MCG, an uplink transmission in one or more slots to the target base station during the DAPS-based handover. The method includes canceling at least one PUCCH repetition associated with the source MCG, the canceled at least one PUCCH repetition overlapping in time with the uplink transmission to the target MCG. The method further includes performing a counting of PUCCH repetitions based, at least in part, on the cancelation of the at least one PUCCH repetition.

### BACKGROUND

### Field of the Disclosure

Aspects of the present disclosure relate to wireless communications, and more particularly, to techniques for handover management.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5 G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5 G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure are directed to a method for wireless communication by a user equipment (UE). The method generally includes transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG. The method includes transmitting, to a target base station associated with the target MCG, an uplink transmission in one or more slots to the target base station during the DAPS-based handover. The method includes canceling at least one PUCCH repetition associated with the source MCG, the canceled at least one PUCCH repetition overlapping in time with the uplink transmission to the target MCG. The method further includes performing a counting of PUCCH repetitions based, at least in part, on the cancelation of the at least one PUCCH repetition.

Certain aspects of the present disclosure are directed to a method for wireless communication by a network entity. The method generally includes transmitting, to a user equipment (UE), a configuration associated with a quantity of physical uplink control channel (PUCCH) repetitions, and receiving, from the UE, a PUCCH repetition in each of one or more slots of a source master cell group (MCG) associated with the source base station during a dual active protocol stack (DAPS)-based handover of the UE from the source MCG to a target MCG. The PUCCH repetitions that overlap in time with an uplink transmission to the target MCG are canceled and a counting of the PUCCH repetitions is based, at least in part, on slots of the source MCG associated with the canceled PUCCH repetitions.

Certain aspects of the present disclosure are directed to an apparatus for wireless communication. The apparatus generally includes at least one processor and memory coupled to the at least one processor. The memory includes code executable by the at least one processor to cause the apparatus to transmit, to a source base station associated with a source master cell group (MCG), a physical uplink control channel (PUCCH) repetition in each of one or more slots of the source MCG during a dual active protocol stack (DAPS)-based handover of the UE from the source MCG to a target MCG; transmit, to a target base station associated with the target MCG, an uplink transmission in one or more slots to the target base station during the DAPS-based handover; cancel at least one PUCCH repetition associated with the source MCG, the canceled at least one PUCCH repetition overlapping in time with the uplink transmission to the target MCG; and perform a counting of PUCCH repetitions based, at least in part, on the cancelation of the at least one PUCCH repetition.

Certain aspects of the present disclosure are directed to an apparatus for wireless communication. The apparatus generally includes a memory and one or more processors coupled to the memory, the memory and the one or more processors being configured to transmit, to a user equipment (UE), a configuration associated with a quantity of physical uplink control channel (PUCCH) repetitions; and receive, from the UE, a PUCCH repetition in each of one or more slots of a source master cell group (MCG) associated with the source base station during a dual active protocol stack (DAPS)-based handover of the UE from the source MCG to a target MCG. The PUCCH repetitions that overlap in time with an uplink transmission to the target MCG are canceled and a counting of the PUCCH repetitions is based at least in part on slots of the source MCG associated with the canceled PUCCH repetitions.

Certain aspects of the present disclosure are directed to an apparatus for wireless communication. The apparatus generally includes means for transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG; means for transmitting, to a target base station associated with the target MCG, an uplink transmission in one or more slots to the target base station during the DAPS-based handover; means for canceling at least one PUCCH repetition associated with the source MCG, the canceled at least one PUCCH repetition overlapping in time with the uplink transmission to the target MCG; and means for performing a counting of PUCCH repetitions based, at least in part, on the cancelation of the at least one PUCCH repetition.

Certain aspects of the present disclosure are directed to an apparatus for wireless communication. The apparatus generally includes means for transmitting, to a user equipment (UE), a configuration associated with a quantity of physical uplink control channel (PUCCH) repetitions; and means for receiving, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

Certain aspects of the present disclosure are directed to a non-transitory computer-readable medium having instructions stored thereon to cause a processor to transmit, to a source base station associated with a source master cell group (MCG), a physical uplink control channel (PUCCH) repetition in each of one or more slots of the source MCG during a dual active protocol stack (DAPS)-based handover of a UE from the source MCG to a target MCG; transmit, to a target base station associated with the target MCG, an uplink transmission in one or more slots to the target base station during the DAPS-based handover; cancel at least one PUCCH repetition associated with the source MCG, the canceled at least one PUCCH repetition overlapping in time with the uplink transmission to the target MCG; and perform a counting of PUCCH repetitions based, at least in part, on the cancelation of the at least one PUCCH repetition.

Certain aspects of the present disclosure are directed to a non-transitory computer-readable medium having instructions stored thereon to cause a processor to transmit, to a user equipment (UE), a configuration associated with a quantity of physical uplink control channel (PUCCH) repetitions; and receive, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example architecture of a distributed radio access network (RAN), in accordance with certain aspects of the present disclosure.

FIG. 3 is a block diagram showing examples for implementing a communication protocol stack in the example RAN architecture, in accordance with certain aspects of the present disclosure.

FIG. 4 is a block diagram conceptually illustrating a design of an example base station (BS) and user equipment (UE), in accordance with certain aspects of the present disclosure.

FIG. 5 illustrates an example system architecture for interworking between a 5 G System (5GS) and an evolved universal mobile telecommunication system network (E-UTRAN) system, in accordance with certain aspects of the present disclosure.

FIG. 6 illustrates an example of a frame format for a telecommunication system, in accordance with certain aspects of the present disclosure.

FIG. 7 is a call flow for dual-active-protocol stack (DAPS) handover, in accordance with certain aspects of the present disclosure.

FIG. 8 illustrates an example of canceling uplink transmissions to a source master cell group (MCG), in accordance with certain aspects of the present disclosure.

FIG. 9 illustrates an example of counting the number of PUCCH repetitions to a source MCG, in accordance with certain aspects of the present disclosure.

FIG. 10 is a flow diagram illustrating example operations for wireless communication by a UE, in accordance with certain aspects of the present disclosure.

FIG. 11 is a flow diagram illustrating example operations for wireless communication by a BS, in accordance with certain aspects of the present disclosure.

FIG. 12 illustrates two example options for counting the number of PUCCH repetitions to a source MCG in a frequency division duplex (FDD) operation in paired spectrum to FDD handover, in accordance with certain aspects of the present disclosure.

FIG. 13 illustrates two example options for counting the number of PUCCH repetitions to a source MCG in a time division duplex (TDD) operation in unpaired spectrum to TDD handover, in accordance with certain aspects of the present disclosure.

FIG. 14 illustrates two example options for counting the number of PUCCH repetitions to a source MCG in a TDD to FDD handover, in accordance with certain aspects of the present disclosure.

FIG. 15 illustrates two example options for counting the number of PUCCH repetitions to a source MCG in a TDD to FDD handover, in accordance with certain aspects of the present disclosure.

FIG. 16 illustrates an example of canceling PUCCH repetition transmission and other remaining PUCCH repetition transmissions in DAPS handover, in accordance with certain aspects of the present disclosure.

FIG. 17 illustrates a communications device that may include various components configured to perform operations for the techniques disclosed herein.

FIG. 18 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

The present disclosure provides techniques for specifying user equipment (UE) behavior when a physical uplink control channel (PUCCH) transmission with repetition(s) is cancelled due to an uplink transmission to a target cell (or base station) of a target master cell group (MCG) during dual-active-protocol stack (DAPS) handover (HO) from a source cell (or base station) associated with a source MCG to the target base station associated with the target MCG. For example, during DAPS HO, a UE is configured to transmit a PUCCH with repetition over a number of slots in a source MCG. In one or more of these configured slots, the UE may transmit an uplink transmission to the target MCG and, consequently, cancel the PUCCH transmission to the source MCG. In some scenarios, the UE counts the slot(s) configured for the cancelled PUCCH transmission to the source MCG toward the number of slots configured for the PUCCH repetitions. In some scenarios, the UE does not count the slot(s) configured for the cancelled PUCCH transmission to the source MCG toward the number of slots configured for the PUCCH repetitions. It is desirable to specify UE behavior when an uplink transmission with repetition to the source MCG is canceled due to an uplink transmission to the target MCG.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5 G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5 G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3 G and/or 4 G wireless technologies, aspects of the present disclosure can be applied in other generation-based communication systems, such as 5 G and later, including NR technologies.

New radio (NR) access (e.g., 5 G technology) may support various wireless communication services, such as enhanced mobile broadband (eDAPS) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

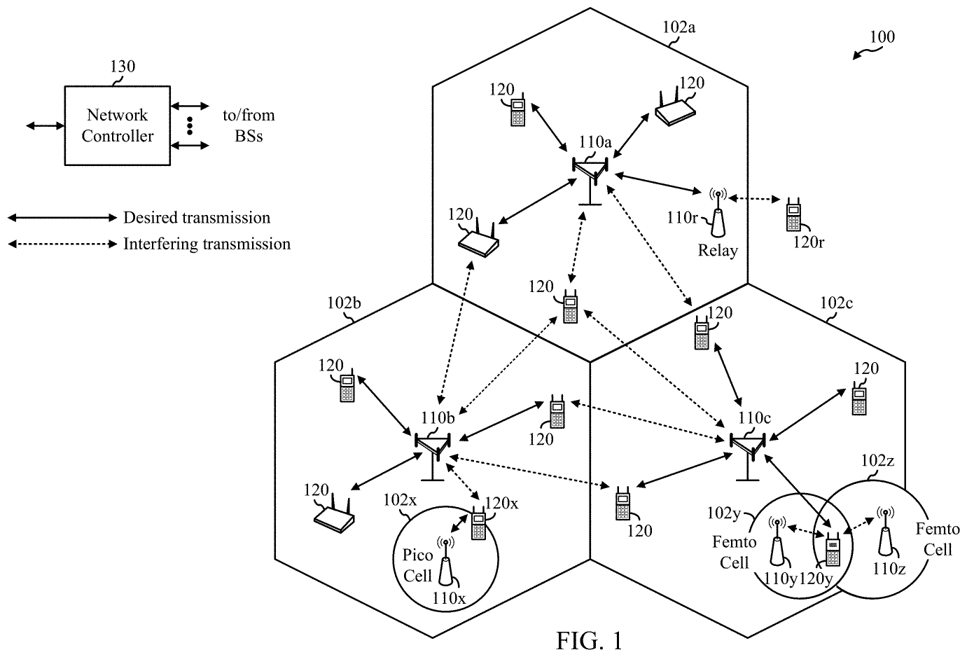

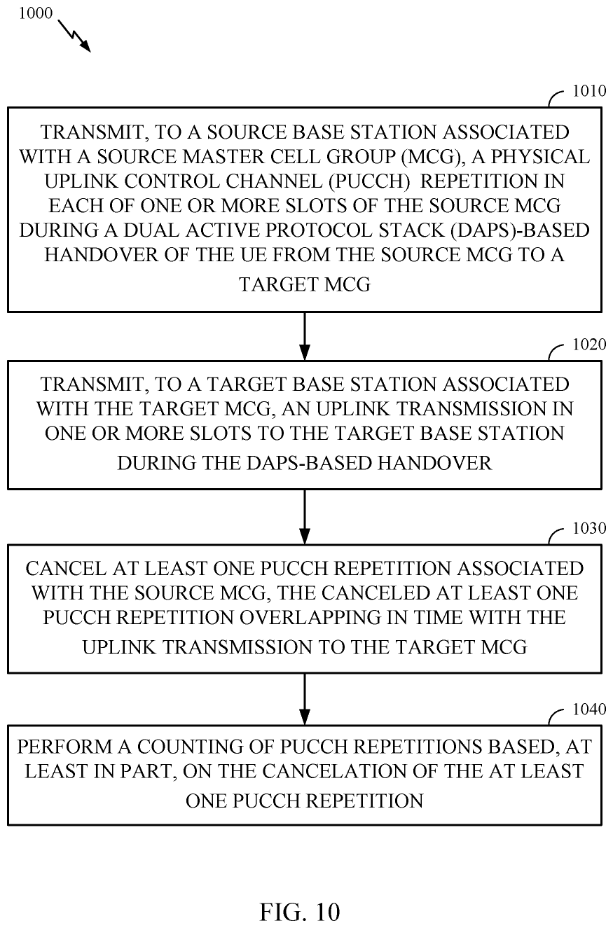

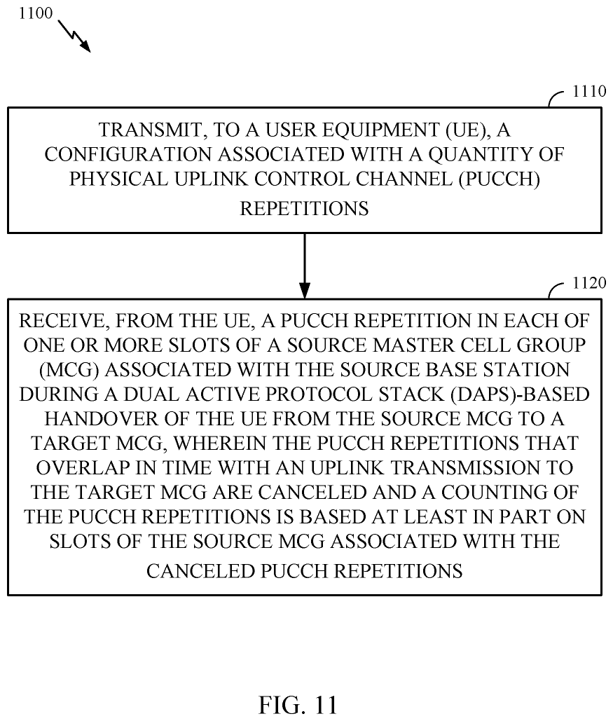

FIG. 1 illustrates an example wireless communication network 100 in which aspects of the present disclosure may be performed. For example, the wireless communication network 100 may be a New Radio (NR) or 5G network. The wireless communication network 100 may include a number of base stations (BSs) 110 and other network entities. A BS may be a station that communicates with user equipments (UEs) 120. The UEs 120 may be configured to perform operations disclosed herein during DAPS HO, such as operations 1000 in FIG. 10. The BSs 110 may be configured to perform operations described herein including operations corresponding to UE operations 1000, such as operations 1100 in FIG. 11.

As illustrated in FIG. 1, each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5 G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

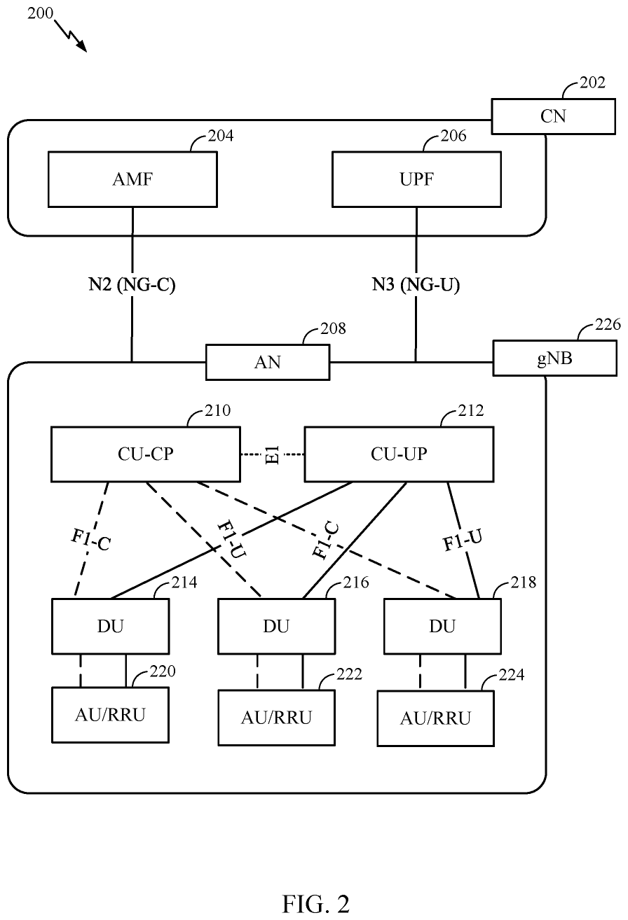

FIG. 2 illustrates an example architecture of a distributed Radio Access Network (RAN) 200, which may be implemented in the wireless communication network 100 illustrated in FIG. 1. As shown in FIG. 2, the distributed RAN includes Core Network (CN) 202 and Access Node 208.

The CN 202 may host core network functions. CN 202 may be centrally deployed. CN 202 functionality may be offloaded (e.g., to advanced wireless services (AWS)), in an effort to handle peak capacity. The CN 202 may include the Access and Mobility Management Function (AMF) 204 and User Plane Function (UPF) 206. The AMF 204 and UPF 206 may perform one or more of the core network functions.

The AN 208 may communicate with the CN 202 (e.g., via a backhaul interface). The AN 208 may communicate with the AMF 204 via an N2 (e.g., NG-C) interface. The AN 208 may communicate with the UPF 208 via an N3 (e.g., NG-U) interface. The AN 208 may include a central unit-control plane (CU-CP) 210, one or more central unit-user plane (CU-UPs) 212, one or more distributed units (DUs) 214-218, and one or more Antenna/Remote Radio Units (AU/RRUs) 220-224. The CUs and DUs may also be referred to as gNB-CU and gNB-DU, respectively. One or more components of the AN 208 may be implemented in a gNB 226. The AN 208 may communicate with one or more neighboring gNBs.

The CU-CP 210 may be connected to one or more of the DUs 214-218. The CU-CP 210 and DUs 214-218 may be connected via a F1-C interface. As shown in FIG. 2, the CU-CP 210 may be connected to multiple DUs, but the DUs may be connected to only one CU-CP. Although FIG. 2 only illustrates one CU-UP 212, the AN 208 may include multiple CU-UPs. The CU-CP 210 selects the appropriate CU-UP(s) for requested services (e.g., for a UE).

The CU-UP(s) 212 may be connected to the CU-CP 210. For example, the DU-UP(s) 212 and the CU-CP 210 may be connected via an E1 interface. The CU-CP(s) 212 may connected to one or more of the DUs 214-218. The CU-UP(s) 212 and DUs 214-218 may be connected via a F1-U interface. As shown in FIG. 2, the CU-CP 210 may be connected to multiple CU-UPs, but the CU-UPs may be connected to only one CU-CP.

A DU, such as DUs 214, 216, and/or 218, may host one or more TRP(s) (transmit/receive points, which may include an Edge Node (EN), an Edge Unit (EU), a Radio Head (RH), a Smart Radio Head (SRH), or the like). A DU may be located at edges of the network with radio frequency (RF) functionality. A DU may be connected to multiple CU-UPs that are connected to (e.g., under the control of) the same CU-CP (e.g., for RAN sharing, radio as a service (RaaS), and service specific deployments). DUs may be configured to individually (e.g., dynamic selection) or jointly (e.g., joint transmission) serve traffic to a UE. Each DU 214-216 may be connected with one of AU/RRUs 220-224. The DU may be connected to an AU/RRU via each of the F1-C and F1-U interfaces.

The CU-CP 210 may be connected to multiple DU(s) that are connected to (e.g., under control of) the same CU-UP 212. Connectivity between a CU-UP 212 and a DU may be established by the CU-CP 210. For example, the connectivity between the CU-UP 212 and a DU may be established using Bearer Context Management functions. Data forwarding between CU-UP(s) 212 may be via a Xn-U interface.

The distributed RAN 200 may support fronthauling solutions across different deployment types. For example, the RAN 200 architecture may be based on transmit network capabilities (e.g., bandwidth, latency, and/or jitter). The distributed RAN 200 may share features and/or components with LTE. For example, AN 208 may support dual connectivity with NR and may share a common fronthaul for LTE and NR. The distributed RAN 200 may enable cooperation between and among DUs 214-218, for example, via the CU-CP 212. An inter-DU interface may not be used.

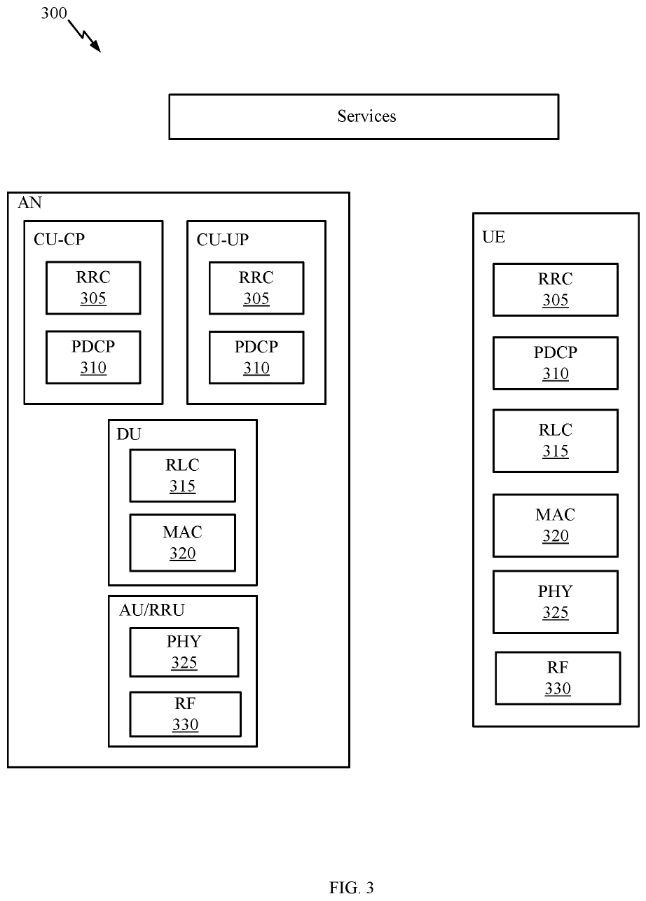

Logical functions may be dynamically distributed in the distributed RAN 200. As will be described in more detail with reference to FIG. 3, the Radio Resource Control (RRC) layer, Packet Data Convergence Protocol (PDCP) layer, Radio Link Control (RLC) layer, Medium Access Control (MAC) layer, Physical (PHY) layers, and/or Radio Frequency (RF) layers may be adaptably placed, in the N AN and/or UE.

FIG. 3 illustrates a diagram showing examples for implementing a communications protocol stack 300 in a RAN (e.g., such as the RAN 200), according to aspects of the present disclosure. The illustrated communications protocol stack 300 may be implemented by devices operating in a wireless communication system, such as a 5G NR system (e.g., the wireless communication network 100). In various examples, the layers of the protocol stack 300 may be implemented as separate modules of software, portions of a processor or ASIC, portions of non-collocated devices connected by a communications link, or various combinations thereof. Collocated and non-collocated implementations may be used, for example, in a protocol stack for a network access device or a UE. As shown in FIG. 3, the system may support various services over one or more protocols. One or more protocol layers of the protocol stack 300 may be implemented by the AN and/or the UE.

As shown in FIG. 3, the protocol stack 300 is split in the AN (e.g., AN 208 in FIG. 2). The RRC layer 305, PDCP layer 310, RLC layer 315, MAC layer 320, PHY layer 325, and RF layer 330 may be implemented by the AN. For example, the CU-CP (e.g., CU-CP 210 in FIG. 2) and the CU-UP e.g., CU-UP 212 in FIG. 2) each may implement the RRC layer 305 and the PDCP layer 310. A DU (e.g., DUs 214-218 in FIG. 2) may implement the RLC layer 315 and MAC layer 320. The AU/RRU (e.g., AU/RRUs 220-224 in FIG. 2) may implement the PHY layer(s) 325 and the RF layer(s) 330. The PHY layers 325 may include a high PHY layer and a low PHY layer.

The UE may implement the entire protocol stack 300 (e.g., the RRC layer 305, the PDCP layer 310, the RLC layer 315, the MAC layer 320, the PHY layer(s) 325, and the RF layer(s) 330).

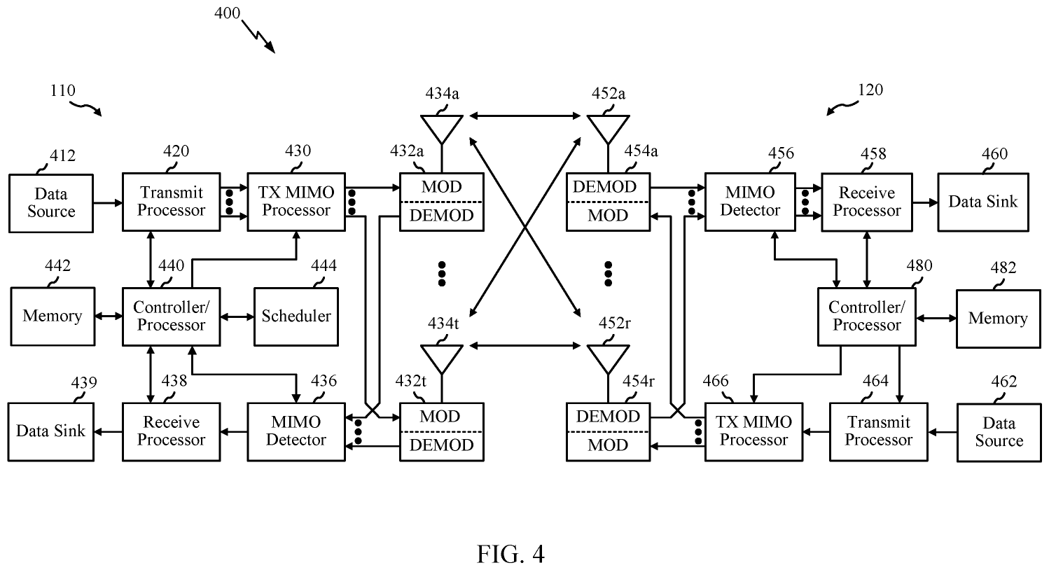

FIG. 4 illustrates an example block diagram 400 having components of BS 110 and UE 120 (as depicted in FIG. 1), which may be used to implement aspects of the present disclosure. For example, antennas 452, processors 466, 458, 464, and/or controller/processor 480 of the UE 120 and/or antennas 434, processors 420, 430, 438, and/or controller/processor 440 of the BS 110 may be used to perform the various techniques and methods described herein, including operations 1000 illustrated in FIG. 10 and operations 1100 illustrated in FIG. 11.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the BS 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

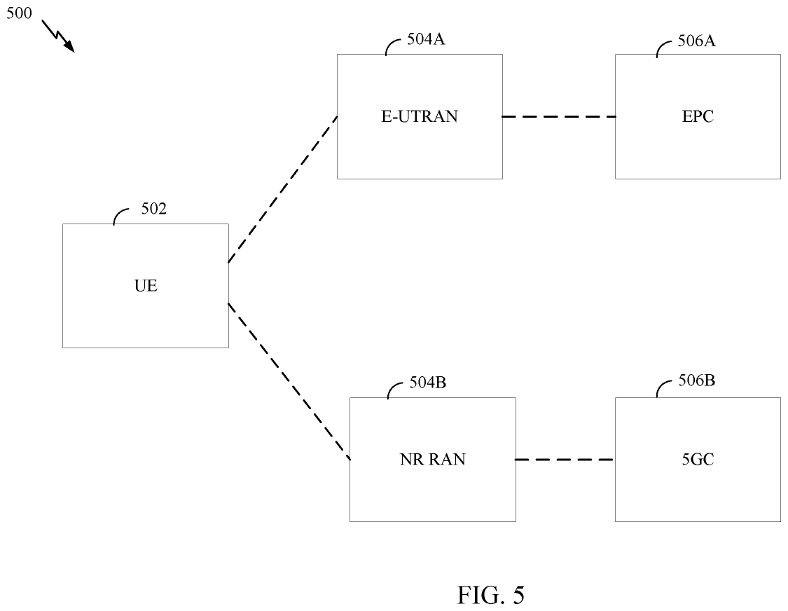

FIG. 5 illustrates an example system architecture 500 for interworking between 5GS (e.g., such as the distributed RAN 200) and E-UTRAN-EPC, in accordance with certain aspects of the present disclosure. As shown in FIG. 5, the UE 502 may be served by separate RANs 504A and 504B controlled by separate core networks 506A and 506B, where the RAN 504A provides E-UTRA services and RAN 504B provides 5 G NR services. The UE may operate under only one RAN/CN or both RANs/CNs at a time.

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

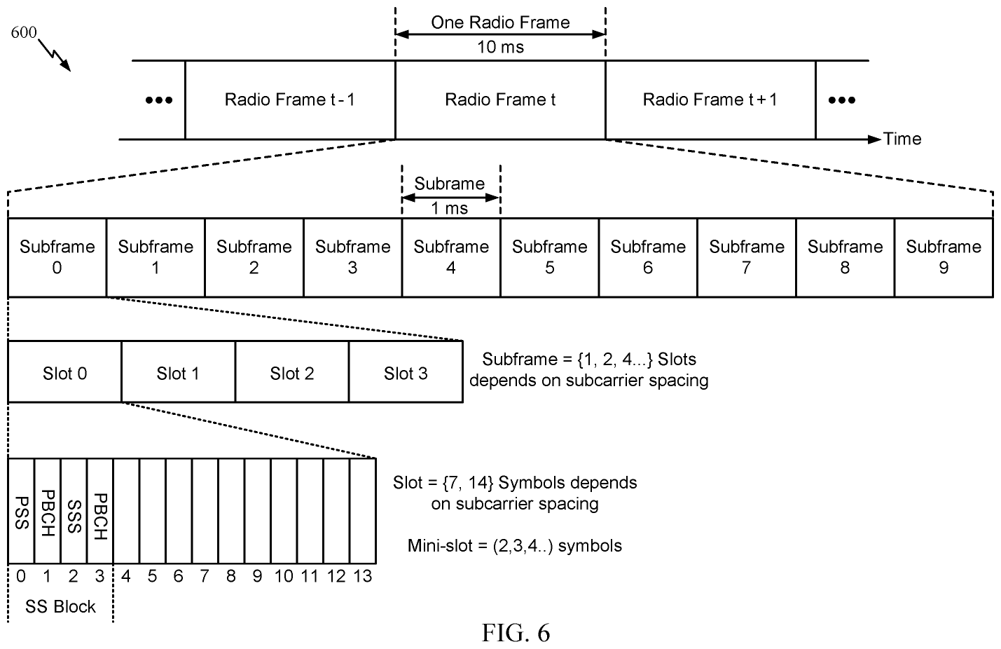

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIB s), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Configuration During Dual Active Protocol Stack (DAPS) Handover (HO)

One of the goals in mobility enhancement is to accomplish little to no interruption time during handover of a user equipment (UE) between cells. In some cases, interruption may be reduced by maintaining the source link during target link establishment using dual active protocol stack (DAPS) handover (HO). During the DAPS HO, the UE may be expected to simultaneously maintain connectivity with the source and target base stations (e.g., gNBs). This simultaneous connectivity to both the source and target base stations may involve certain beams/panels at the UE being used for transmission and reception to and from the source and target cells. Thus, the UE may maintain two separate protocol stacks during a DAPS HO. Certain aspects of the present disclosure are generally directed to techniques for DAPS HO. DAPS HO may be applicable to intra-frequency HO, intra-band inter-frequency HO, and inter-band inter-frequency HO.

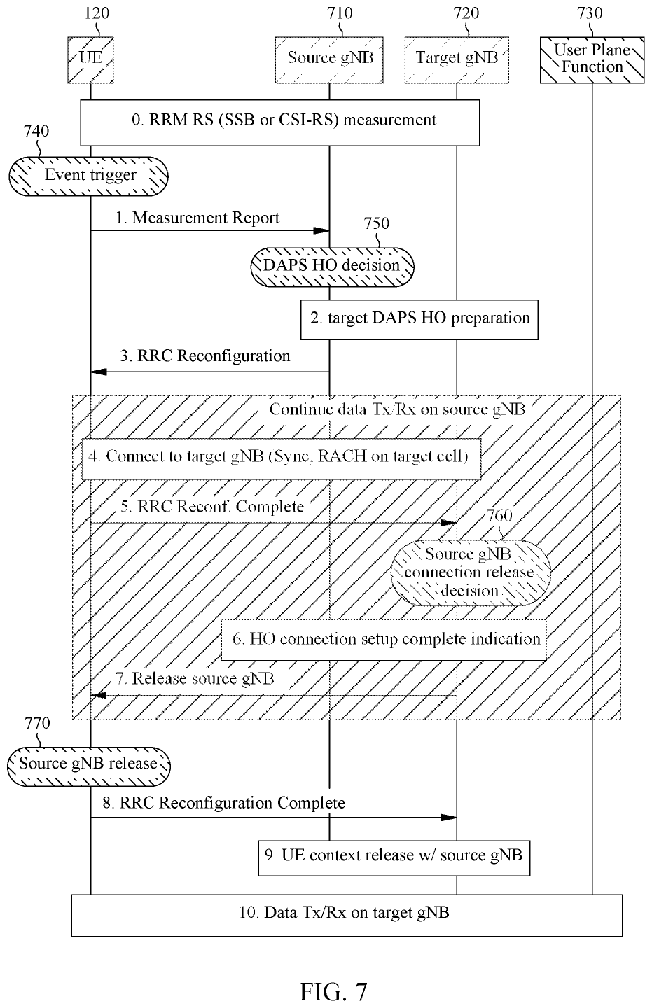

FIG. 7 is a call flow diagram for a DAPS HO, in accordance with certain aspects of the present disclosure. The source gNB 710 and the target gNB 720 may include any of the components illustrated at 110 in FIG. 4. As illustrated, at step 0, the UE 120 performs measurements of one or more synchronization signal blocks (SSBs) or channel state information (CSI) reference signals (RSs). Upon an event trigger 740, the UE 120 may transmit, at step 1, a measurement report to a source gNB 710 (or a source master cell group (MCG)). Based on the measurement report, the source gNB 710 may make a DAPS HO decision 750.

At step 2, the source gNB 710 and a target gNB 720 prepare for the target DAPS HO. At step 3, the source gNB 110 transmits a radio resource control (RRC) reconfiguration message to the UE 120. The RRC reconfiguration message may configure the DAPS HO such that the UE maintains connection with both the target gNB 720 and the source gNBs 710 during a HO. The RRC reconfiguration message may also configure a type of connection to be maintained during the HO (e.g., single carrier, CA, or a dormancy CA) with the target and source gNBs 720 and 710.

At step 4, the UE 120 connects to the target gNB 720. At step 5, the RRC reconfiguration for the target gNB 720 is completed. The target gNB 720 may then make a source gNB connection decision at 760. At step 6, the target gNB 720 indicates to the source gNB 710 that the HO connection setup is complete. At step 7, the target gNB 720 indicates to the UE 120 to release the connection to the source gNB 710. The UE 120 then releases the connection to the source gNB 710 at 770. At step 8, the UE reports to the target gNB 720 that the RRC reconfiguration is complete. At step 9, the UE release its context with the source gNB 710. At step 10, the UE 120 performs data transmission and reception with the target gNB 720.

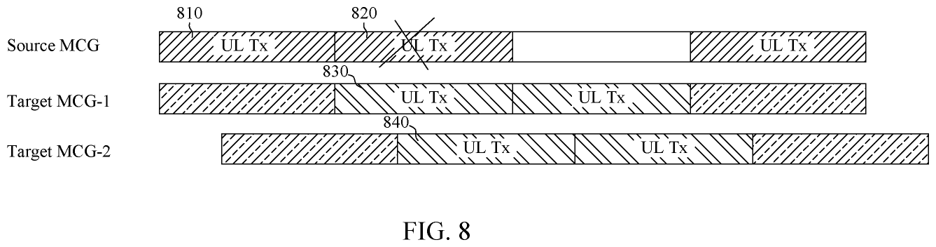

FIG. 8 illustrates an example of canceling uplink transmissions to a source MCG, in accordance with certain aspects of the present disclosure. Two example timelines for the uplink transmissions to two example target MCGs (1 and 2) are illustrated for showing full slot overlap and partial slot overlap.

In a first scenario, the UE performs a DAPS HO from the source gNB to a target MCG-1. As shown, in FIG. 8, when the UE 120 is connected to both the source gNB 710 and the target gNB 720 having a timeline shown by target MCG-1, the UE transmits to the source gNB at 810. As shown in the target MCG-1 timeline, the UE's uplink transmission to the target MCG-1 in slot 830 completely overlaps the UE's scheduled uplink transmission to the source gNB in slot 820. Therefore, the UE cancels the scheduled uplink transmission 820 to the source gNB 710 (a source MCG) and transmits to the target MCG-1 at 830.

In a second scenario, the UE performs a DAPS HO from the source gNB to a target MCG-2. As shown, in FIG. 8, when the UE 120 is connected to both the source gNB 710 and the target gNB 720 having a timeline shown by target MCG-2, the UE transmits to the source gNB at 810. As shown in the target MCG-2 timeline, the UE's uplink transmission to the target MCG-2 in slot 840 partially overlaps the UE's scheduled uplink transmission to the source gNB in slot 820. Therefore, the UE cancels the scheduled uplink transmission 820 to the source gNB 710 (a source MCG) and transmits to the target MCG-2 at 840.

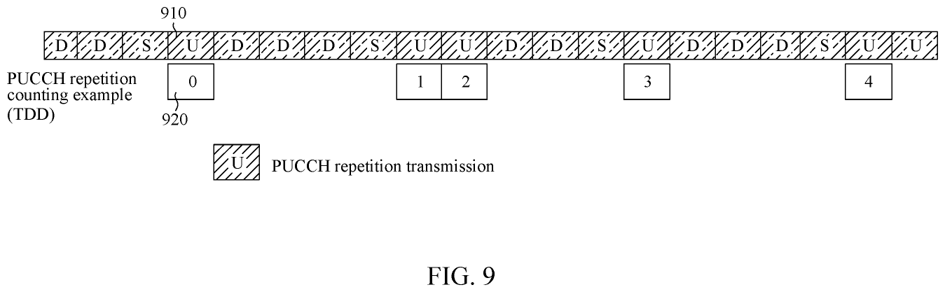

FIG. 9 illustrates an example of counting the number of PUCCH repetitions to a source MCG in TDD, in accordance with certain aspects of the present disclosure. In a PUCCH repetition procedure, for PUCCH formats 1, 3, or 4, a UE can be configured a number of slots, N^{repeat}_{PUCCH}for repetitions of a PUCCH transmission by respective nrofSlots. If a UE is provided a PUCCH-config that includes subslotLengthForPUCCH, the UE does not expect the PUCCH-config to include nrofSlots. When N^{repeat}_{PUCCH} is greater than 1, the UE may repeat the PUCCH transmission with the UCI over N^{repeat}_{PUCCH}slots. A PUCCH transmission in each of the N^{repeat}_{PUCCH}slots may have a same number of consecutive symbols. A PUCCH transmission in each of the N^{repeat}_{PUCCH}slots has a same first symbol.

In some cases, if a UE transmits a PUCCH over N^{repeat}_{PUCCH}slots and the UE does not transmit the PUCCH in a slot from the N^{repeat}_{PUCCH}slots due to overlapping with another PUCCH transmission in the slot (for example, to the target), the UE counts the slot in the number of N^{repeat}_{PUCCH}slots. As shown in FIG. 9, the UE performs counting 920 (0, 1, 2, . . . ) of the uplink transmission slots 910 toward N^{repeat}_{PUCCH}. If a UE would transmit a PUCCH over N^{repeat}_{PUCCH}slots and the UE does not transmit the PUCCH in a slot from the N^{repeat}_{PUCCH}slots due to overlapping with another PUCCH transmission in the slot, the UE counts the slot in the number of N^{repeat}_{PUCCH}slots.

The present disclosure provides specification to cases where the PUCCH transmission with repetition to the source is cancelled by an uplink transmission to a target MCG during a DAPS HO.

FIG. 10 is a flow diagram illustrating example operations 1000 for wireless communication, in accordance with certain aspects of the present disclosure. The operations 1000 may be performed, for example, by UE (e.g., such as UE 120 in the wireless communication network 100).

Operations 1000 may be implemented as software components that are executed and run on one or more processors (e.g., processor 480 of FIG. 4). Further, the transmission and reception of signals by the UE in operations 1000 may be enabled, for example, by one or more antennas (e.g., antennas 452 of FIG. 4). In certain aspects, the transmission and/or reception of signals by the UE may be implemented via a bus interface of one or more processors (e.g., processor 480) obtaining and/or outputting signals.

The operations 1000 begins, at block 1010, by the UE transmitting to a source base station associated with a source MCG, a PUCCH repetition in each of one or more slots of the source MCG during a DAPS-based handover of the UE from the source MCG to a target MCG. At 1020, the UE transmits to a target base station associated with the target MCG, an uplink transmission in one or more slots to the target base station during the DAPS-based handover. At 1030, the UE cancels at least one PUCCH repetition associated with the source MCG, the canceled at least one PUCCH repetition overlapping in time with the uplink transmission to the target MCG. At 1040, the UE performs a counting of PUCCH repetitions based, at least in part, on the cancelation of the at least one PUCCH repetition.

FIG. 11 is a flow diagram illustrating example operations 1100 for wireless communication, in accordance with certain aspects of the present disclosure. The operations 1100 may be performed, for example, by a BS (e.g., such as a BS 110 in the wireless communication network 100, or the source gNB 710 in FIG. 7). The operations 1100 may be complementary to the operations 1000 by the UE of FIG. 10.

Operations 1100 may be implemented as software components that are executed and run on one or more processors (e.g., processor 440 of FIG. 4). Further, the transmission and reception of signals by the BS in operations 1100 may be enabled, for example, by one or more antennas (e.g., antennas 434 of FIG. 4). In certain aspects, the transmission and/or reception of signals by the BS may be implemented via a bus interface of one or more processors (e.g., processor 440) obtaining and/or outputting signals.

The operations 1100 may begin, at 1110 by transmitting, to a UE, a configuration associated with a quantity PUCCH repetitions. At 1120, the network entity receives, from the UE, a PUCCH repetition in each of one or more slots of a source MCG associated with the source base station during a DAPS-based handover of the UE from the source MCG to a target MCG. The PUCCH repetitions that overlap in time with an uplink transmission to the target MCG are canceled. A counting of the PUCCH repetitions is based, at least in part, on slots of the source MCG associated with the canceled PUCCH repetitions.

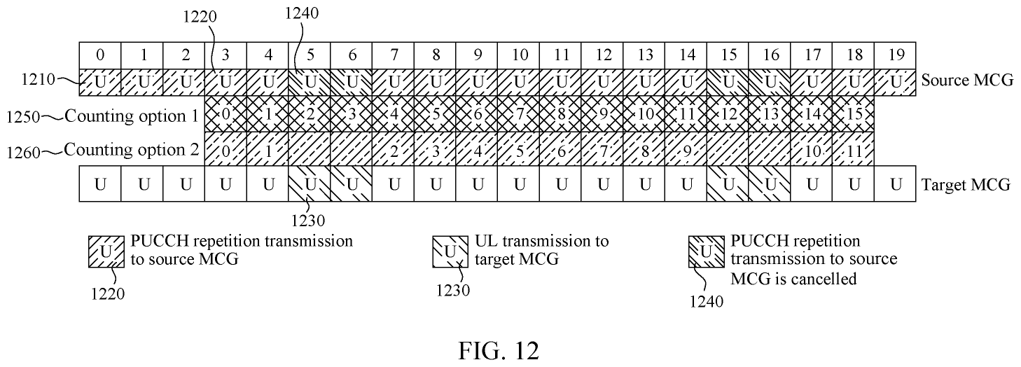

In aspects, the counting of the PUCCH repetitions includes counting the slots of the source MCG associated with the canceled PUCCH repetitions. For example, counting N^{repeat}_{PUCCH}slots includes the slots of the source MCG that are canceled due to an overlapping of slots of uplink transmissions transmitted to the target MCG. An example is illustrated in FIG. 12.

FIG. 12 illustrates two example options for counting the number of PUCCH repetitions to a source MCG in a frequency division duplex (FDD) operation in a paired spectrum to FDD handover. As shown in option 1 of FIG. 12, among the number of uplink transmission slots 1210, PUCCH repetition transmission in slots 1220 are transmitted to the source MCG, while PUCCH repetitions transmissions in slots 1240 are cancelled due to the uplink transmission 1230 to the target MCG. According to option 1, the cancelled PUCCH repetitions in slots 1240 are included in the counting 1250 of the number of PUCCH repetitions.

In aspects, the counting of the PUCCH repetitions includes not counting the slots of the source MCG associated with the canceled PUCCH repetitions. As shown in FIG. 12, in option 2, the PUCCH repetitions in slots 1240 cancelled due to the uplink transmission 1230 to the target MCG are not included in the counting 1260 of the number of PUCCH repetitions.

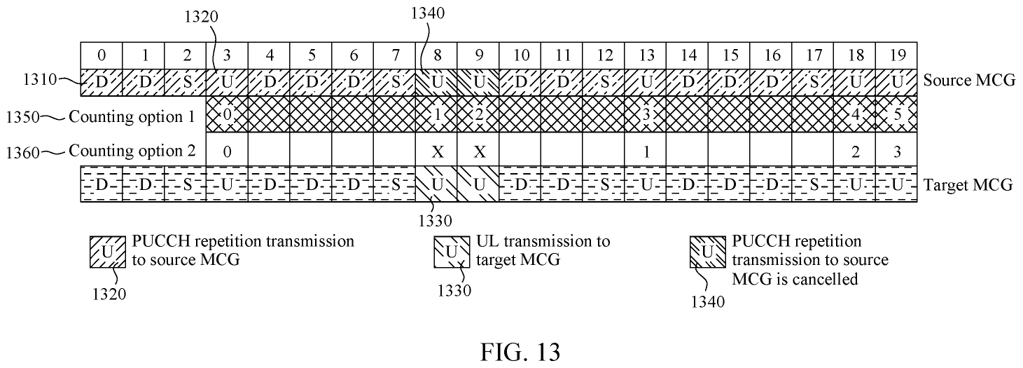

In some aspects, the PUCCH repetitions associated with the source MCG fully overlap in time with the uplink transmission to the target MCG. For example, in the examples illustrated in FIG. 12, the PUCCH repetitions 1240 fully overlap in time with the uplink transmissions 1230 to the target MCG. FIGS. 13-16 illustrate a similar complete slot overlap as FIG. 12. In some aspects, the PUCCH repetitions associated with the source MCG partially overlap in time with the uplink transmission to the target MCG. An example of partial overlap is illustrated in FIG. 8 and such partial overlap may also apply to the examples shown in FIGS. 12-16.

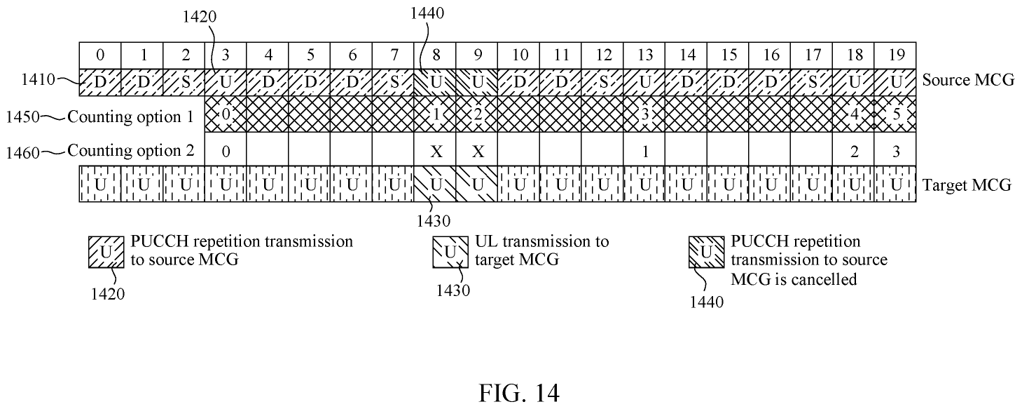

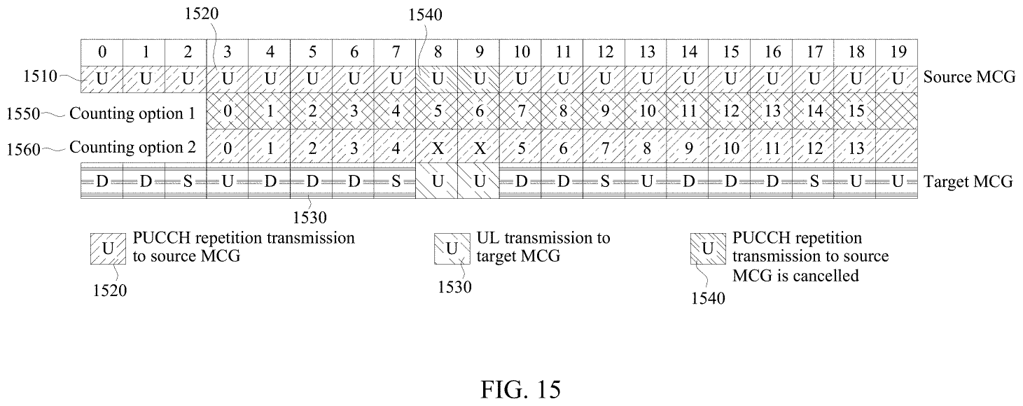

In aspects, the uplink transmission in the one or more slots of the target MCG during the DAPS-based handover is one of: a PUCCH transmission, a physical uplink shared channel (PUSCH) transmission, a sounding reference signal (SRS), a physical random access channel transmission (PRACH), a message 3 (Msg3) PUSCH transmission of a four-step random access channel (RACH) procedure, or a message (MsgA) of a two-step RACH procedure. For example, the uplink transmission 1230 of FIG. 12, the uplink transmission 1330 of FIG. 13, the uplink transmission 1430 of FIG. 14, and the uplink transmission 1530 of FIG. 15 may include one or more of the PUCCH, PUSCH, SRS, or other types of uplink transmissions.

In aspects, the DAPS-based handover is associated with at least one of a frequency division duplexing (FDD)-to-FDD handover, a time division duplexing (TDD)-to-TDD handover, a TDD-to-FDD handover, or an FDD-to-TDD handover, wherein FDD is associated with a paired spectrum and TDD is associated with an unpaired spectrum. For example, FIG. 12 illustrates an FDD to FDD handover, FIG. 13 illustrates a TDD to TDD handover, FIG. 14 illustrates a TDD to FDD handover, and FIG. 15 illustrates an FDD to TDD handover, as discussed below.

FIG. 13 illustrates two example options for counting the number of PUCCH repetitions to a source MCG in a time division duplex (TDD) operation in unpaired spectrum to TDD handover. As shown, the slots 1310 may include downlink slots (D), special slots (S), and uplink slots (U) 1320. The downlink slots may include downlink symbols. The special slots may contain downlink symbols (N_{d}), uplink symbols (Nᵤ), and/or flexible symbols (N_{f}). The uplink slots may contain uplink symbols only. In option 1, during PUCCH repetition uplink transmissions to the source MCG, all uplink slots scheduled for the PUCCH repetitions are included in the counting 1350, including the uplink transmissions to the source MCG that are canceled due to uplink transmissions 1330 to the target MCG. In option 2, the uplink slots 1340 canceled due to the uplink transmissions 1330 to the target MCG are not included in the counting 1360.

FIG. 14 illustrates two example options for counting the number of PUCCH repetitions to a source MCG in a TDD to FDD handover. As shown, the slots 1410 may include downlink transmissions (D), special slots (S), and uplink transmissions (U) 1420. In option 1, during PUCCH repetition uplink transmissions to the source MCG, all uplink slots scheduled for the PUCCH repetitions are included in the counting 1450, including the ones canceled due to uplink transmissions 1430 to the target MCG. In option 2, the uplink slots 1440 canceled due to the uplink transmissions 1430 to the target MCG are not included in the counting 1460.

FIG. 15 illustrates two example options for counting the number of PUCCH repetitions to a source MCG in a TDD to FDD handover. As shown, the slots 1510 may include uplink transmissions (U) 1520 to the source MCG. In option 1, during PUCCH repetition uplink transmissions to the source MCG, all uplink slots scheduled for the PUCCH repetitions are included in the counting 1550, including the ones canceled due to uplink transmissions 1530 to the target MCG. In option 2, the uplink slots 1540 canceled due to the uplink transmissions 1530 to the target MCG are not included in the counting 1560.

In some aspects, the PUCCH repetitions may have a same time domain resource allocation in each of the one or more slots of the source MCG. The time domain resource allocation may include a starting symbol and a duration of the transmission.

In some aspects, the UE may cancel the PUCCH repetitions associated with the source MCG based, at least in part, on a lack of UE capability for power sharing between the source MCG and the target MCG during the DAPS-based handover.

In some aspects, the UE may cancel the PUCCH repetitions associated with the source MCG based, at least in part, on a UE capability of canceling uplink transmissions during the DAPS-based handover.

In some aspects, the UE may cancel the PUCCH repetitions associated with the source MCG based, at least in part, on an intra-frequency DAPS-based handover.

In some aspects, the one or more slots of the source MCG include one or more of uplink slots or special slots. The one or more slots of the target MCG include one or more of uplink slots or special slots.

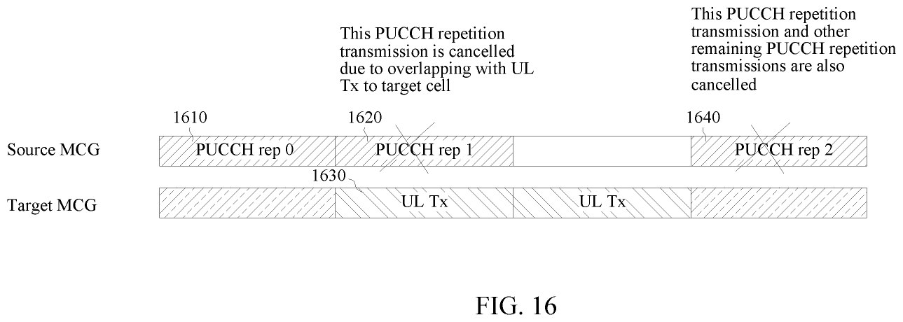

In some aspects, the UE may completely end or cancel the PUCCH repetitions and associated repetitions to the source MCG upon canceling the at least one PUCCH repetition. That is, if UE transmission of a PUCCH repetition k on source cell is cancelled due to the overlapping in time with UE transmission on the target cell, the UE cancels all PUCCH repetition transmissions after PUCCH repetition k on the source cell. For example FIG. 16 illustrates an example of canceling PUCCH repetition transmission and other remaining PUCCH repetition transmissions in DAPS handover. As shown, the UE transmits the PUCCH repetition 1610 to the source MCG and cancels the PUCCH repetition 1620 in view of the uplink transmission 1630 to the target MCG. In addition to canceling the PUCCH repetition 1620, the UE also cancels subsequent PUCCH repetitions 1640 and associated repetitions to the source MCG.

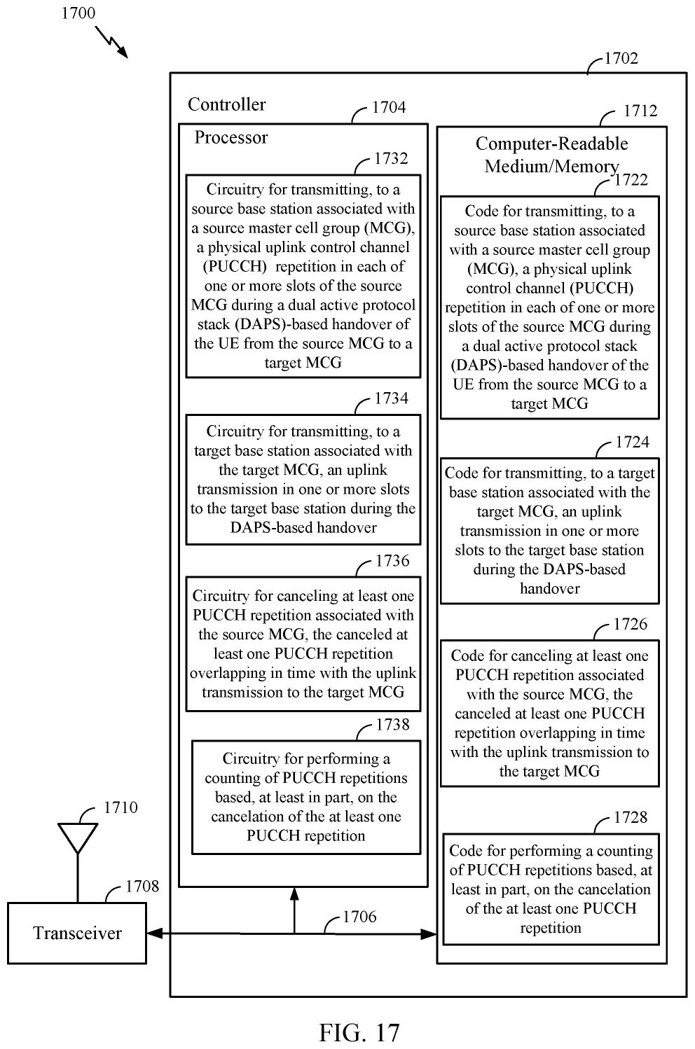

FIG. 17 illustrates a communications device 1700 that may include various components (e.g., corresponding to means-plus-function components) configured to perform operations for the techniques disclosed herein, such as the operations illustrated in FIG. 10. The communications device 1700 includes a processing system 1702 coupled to a transceiver 1708 (e.g., a transmitter and/or a receiver). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations illustrated in FIG. 10, or other operations for performing the various techniques discussed herein for DAPS HO. In certain aspects, computer-readable medium/memory 1712 stores code 1722 for transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG, 1724 for transmitting, to a target base station associated with the target MCG, an uplink transmission in one or more slots to the target base station during the DAPS-based handover, 1726 for, and 1728 for performing a counting of PUCCH repetitions based, at least in part, on the cancelation of the at least one PUCCH repetition.

In certain aspects, the processor 1704 has circuitry configured to implement the code stored in the computer-readable medium/memory 1712. The processor 1704 includes circuitry 1732 for transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG; circuitry 1734 for transmitting, to a target base station associated with the target MCG, an uplink transmission in one or more slots to the target base station during the DAPS-based handover; circuitry 1736 for canceling at least one PUCCH repetition associated with the source MCG, the canceled at least one PUCCH repetition overlapping in time with the uplink transmission to the target MCG; and circuitry 1738 for performing a counting of PUCCH repetitions based, at least in part, on the cancelation of the at least one PUCCH repetition.

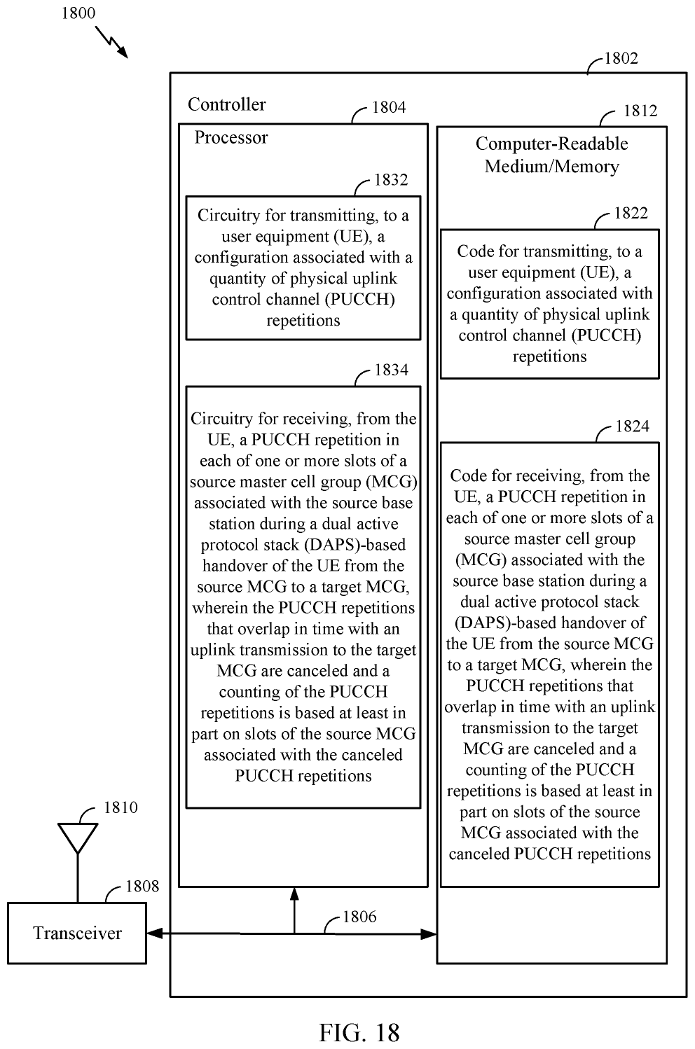

FIG. 18 illustrates a communications device 1800 that may include various components (e.g., corresponding to means-plus-function components) configured to perform operations for the techniques disclosed herein, such as the operations illustrated in FIG. 11. The communications device 1800 includes a processing system 1802 coupled to a transceiver 1808 (e.g., a transmitter and/or a receiver). The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes a processor 1804 coupled to a computer-readable medium/memory 1812 via a bus 1806. In certain aspects, the computer-readable medium/memory 1812 is configured to store instructions (e.g., computer-executable code) that when executed by the processor 1804, cause the processor 1804 to perform the operations illustrated in FIG. 11, or other operations for performing the various techniques discussed herein for DAPS HO. In certain aspects, computer-readable medium/memory 1812 stores code 1822 for transmitting, to a user equipment (UE), a configuration associated with a quantity of physical uplink control channel (PUCCH) repetitions; and code 1824 for receiving, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

In certain aspects, the processor 1804 has circuitry configured to implement the code stored in the computer-readable medium/memory 1812. The processor 1804 includes circuitry 1832 for transmitting, to a user equipment (UE), a configuration associated with a quantity of physical uplink control channel (PUCCH) repetitions; and circuitry 1834 for receiving, from the UE, a PUCCH repetition in each of one or more slots of a source MCG associated with the source base station during a DAPS-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

### Example Aspects

Aspect 1: A method of wireless communication performed by a user equipment (UE), comprising: transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG; transmitting, to a target base station associated with the target MCG, an uplink transmission in one or more slots to the target base station during the DAPS-based handover; canceling at least one PUCCH repetition associated with the source MCG, the canceled at least one PUCCH repetition overlapping in time with the uplink transmission to the target MCG; and performing a counting of PUCCH repetitions based, at least in part, on the cancelation of the at least one PUCCH repetition.

Aspect 2: The method of Aspect 1, wherein the counting of the PUCCH repetitions includes counting the slots of the source MCG associated with the canceled PUCCH repetitions.

Aspect 3: The method of Aspect 1, wherein the counting of the PUCCH repetitions includes not counting the slots of the source MCG associated with the canceled PUCCH repetitions.

Aspect 4: The method of any one of Aspects 1 to 3, wherein the PUCCH repetitions associated with the source MCG fully overlap in time with the uplink transmission to the target MCG.

Aspect 5: The method of any one of Aspects 1 to 4, wherein the PUCCH repetitions associated with the source MCG partially overlap in time with the uplink transmission to the target MCG.

Aspect 6: The method of any one of Aspects 1 to 5, wherein the uplink transmission in the one or more slots of the target MCG during the DAPS-based handover is one of: a PUCCH transmission, a physical uplink shared channel (PUSCH) transmission, a sounding reference signal (SRS), a physical random access channel transmission (PRACH), a message 3 (Msg3) PUSCH transmission of a four-step random access channel (RACH) procedure, or a message (MsgA) of a two-step RACH procedure.

Aspect 7: The method of any one of Aspects 1 to 6, wherein the DAPS-based handover is associated with at least one of a frequency division duplexing (FDD)-to-FDD handover, a time division duplexing (TDD)-to-TDD handover, a TDD-to-FDD handover, or an FDD-to-TDD handover, wherein FDD is associated with a paired spectrum and TDD is associated with an unpaired spectrum.

Aspect 8: The method of any one of Aspects 1 to 7, wherein the PUCCH repetitions have a same time domain resource allocation in each of the one or more slots of the source MCG.

Aspect 9: The method of any one of Aspects 1 to 8, further comprising: canceling the PUCCH repetitions associated with the source MCG based, at least in part, on a lack of UE capability for power sharing between the source MCG and the target MCG during the DAPS-based handover.

Aspect 10: The method of any one of Aspects 1 to 9, further comprising: canceling the PUCCH repetitions associated with the source MCG based at least in part on a UE capability of canceling uplink transmissions during the DAPS-based handover.

Aspect 11: The method of any one of Aspects 1 to 10, further comprising: canceling the PUCCH repetitions associated with the source MCG based, at least in part, on an intra-frequency DAPS-based handover.

Aspect 12: The method of any one of Aspects 1 to 11, wherein: the one or more slots of the source MCG include one or more of uplink slots or special slots; and the one or more slots of the target MCG include one or more of uplink slots or special slots.

Aspect 13: The method of any one of Aspects 1 to 12, further comprising ending the PUCCH repetitions and associated repetitions to the source MCG upon canceling the at least one PUCCH repetition.

Aspect 14: A method of wireless communication performed by a source base station, comprising: transmitting, to a user equipment (UE), a configuration associated with a quantity of physical uplink control channel (PUCCH) repetitions; and receiving, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

Aspect 15: The method of Aspect 14, wherein the counting of the PUCCH repetitions is based, at least in part, on counting the slots of the source MCG associated with the canceled PUCCH repetitions.

Aspect 16: The method of Aspect 14, wherein the counting of the PUCCH repetitions is based at least in part on not counting the slots of the source MCG associated with the canceled PUCCH repetitions.

Aspect 17: An apparatus for wireless communication, comprising: at least one processor; and memory coupled to the at least one processor, the memory including code executable by the at least one processor to cause the apparatus to: transmit, to a source base station associated with a source master cell group (MCG), a physical uplink control channel (PUCCH) repetition in each of one or more slots of the source MCG during a dual active protocol stack (DAPS)-based handover of the UE from the source MCG to a target MCG; transmit, to a target base station associated with the target MCG, an uplink transmission in one or more slots to the target base station during the DAPS-based handover; cancel at least one PUCCH repetition associated with the source MCG, the canceled at least one PUCCH repetition overlapping in time with the uplink transmission to the target MCG; and perform a counting of PUCCH repetitions based, at least in part, on the cancelation of the at least one PUCCH repetition.

Aspect 18: The apparatus of Aspect 17, wherein in order to perform the counting of the PUCCH repetitions, the memory further includes code executable by the at least one processor to cause the apparatus to count the slots of the source MCG associated with the canceled PUCCH repetitions.

Aspect 19: The apparatus of Aspect 17, wherein in order to perform the counting of the PUCCH repetitions, the memory further includes code executable by the at least one processor to cause the apparatus not to count the slots of the source MCG associated with the canceled PUCCH repetitions.

Aspect 20: The apparatus of any one of Aspects 17 to 19, wherein the uplink transmission in the one or more slots of the target MCG during the DAPS-based handover is one of: a PUCCH transmission, a physical uplink shared channel (PUSCH) transmission, a sounding reference signal (SRS), a physical random access channel transmission (PRACH), a message 3 (Msg3) PUSCH transmission of a four-step random access channel (RACH) procedure, or a message (MsgA) of a two-step RACH procedure.

Aspect 21: The apparatus of any one of Aspects 17 to 20, wherein the DAPS-based handover is associated with a frequency division duplexing (FDD)-to-FDD handover, a time division duplexing (TDD)-to-TDD handover, a TDD-to-FDD handover, or an FDD-to-TDD handover, wherein FDD is associated with a paired spectrum and TDD is associated with an unpaired spectrum.

Aspect 22: The apparatus of any one of Aspects 17 to 21, wherein the PUCCH repetitions have a same time domain resource allocation in each of the one or more slots of the source MCG.

Aspect 23: The apparatus of any one of Aspects 17 to 22, wherein the one or more processors are further configured to: cancel the PUCCH repetitions associated with the source MCG based at least in part on a lack of UE capability for power sharing between the source MCG and the target MCG during the DAPS-based handover.

Aspect 24: The apparatus of any one of Aspects 17 to 23, wherein the at least one processor causes the apparatus to: cancel the PUCCH repetitions associated with the source MCG based at least in part on a UE capability of canceling uplink transmissions during the DAPS-based handover.

Aspect 25: The apparatus of any one of Aspects 17 to 24, wherein the at least one processor causes the apparatus to: cancel the PUCCH repetitions associated with the source MCG based at least in part on an intra-frequency DAPS-based handover.

Aspect 26: The apparatus of any one of Aspects 17 to 25, wherein: the one or more slots of the source MCG include one or more of uplink slots or special slots; and the one or more slots of the target MCG include one or more of uplink slots or special slots.

Aspect 27: The apparatus of any one of Aspects 17 to 26, wherein the at least one processor causes the apparatus to end the PUCCH repetitions and associated repetitions to the source MCG upon canceling the at least one PUCCH repetition.

Aspect 28: An apparatus for wireless communication, comprising: at least one processor; and memory coupled to the at least one processor, the memory including code executable by the at least one processor to cause the apparatus to: transmit, to a user equipment (UE), a configuration associated with a quantity of physical uplink control channel (PUCCH) repetitions; and receive, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions

Aspect 29: The apparatus of Aspect 28, wherein the counting of the PUCCH repetitions is based, at least in part, on counting the slots of the source MCG associated with the canceled PUCCH repetitions.

Aspect 30: The apparatus of Aspect 28, wherein the counting of the PUCCH repetitions is based at least in part on not counting the slots of the source MCG associated with the canceled PUCCH repetitions.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communication performed by a user equipment (UE), comprising:
transmitting, to a source base station associated with a source master cell group (MCG), a physical uplink control channel (PUCCH) repetition in each of one or more slots of the source MCG during a dual active protocol stack (DAPS)-based handover of the UE from the source MCG to a target MCG;
transmitting, to a target base station associated with the target MCG, an uplink transmission in one or more slots to the target base station during the DAPS-based handover;
canceling at least one PUCCH repetition associated with the source MCG, the canceled at least one PUCCH repetition overlapping in time with the uplink transmission to the target MCG; and
performing a counting of PUCCH repetitions based, at least in part, on the cancelation of the at least one PUCCH repetition.

2. The method of claim 1, wherein the counting of the PUCCH repetitions includes counting the slots of the source MCG associated with the canceled PUCCH repetitions.

3. The method of claim 1, wherein the counting of the PUCCH repetitions includes not counting the slots of the source MCG associated with the canceled PUCCH repetitions.

4. The method of claim 1, wherein the PUCCH repetitions associated with the source MCG fully overlap in time with the uplink transmission to the target MCG.

5. The method of claim 1, wherein the PUCCH repetitions associated with the source MCG partially overlap in time with the uplink transmission to the target MCG.

6. The method of claim 1, wherein the uplink transmission in the one or more slots of the target MCG during the DAPS-based handover is one of: a PUCCH transmission, a physical uplink shared channel (PUSCH) transmission, a sounding reference signal (SRS), a physical random access channel transmission (PRACH), a message 3 (Msg3) PUSCH transmission of a four-step random access channel (RACH) procedure, or a message (MsgA) of a two-step RACH procedure.

7. The method of claim 1, wherein the DAPS-based handover is associated with at least one of a frequency division duplexing (FDD)-to-FDD handover, a time division duplexing (TDD)-to-TDD handover, a TDD-to-FDD handover, or an FDD-to-TDD handover, wherein FDD is associated with a paired spectrum and TDD is associated with an unpaired spectrum.

8. The method of claim 1, wherein the PUCCH repetitions have a same time domain resource allocation in each of the one or more slots of the source MCG.

9. The method of claim 1, further comprising:
canceling the PUCCH repetitions associated with the source MCG based, at least in part, on a lack of UE capability for power sharing between the source MCG and the target MCG during the DAPS-based handover.

10. The method of claim 1, further comprising:
canceling the PUCCH repetitions associated with the source MCG based at least in part on a UE capability of canceling uplink transmissions during the DAPS-based handover.

11. The method of claim 1, further comprising:
canceling the PUCCH repetitions associated with the source MCG based, at least in part, on an intra-frequency DAPS-based handover.

12. The method of claim 1, wherein:
the one or more slots of the source MCG include one or more of uplink slots or special slots; and
the one or more slots of the target MCG include one or more of uplink slots or special slots.

13. The method of claim 1, further comprising ending the PUCCH repetitions and associated repetitions to the source MCG upon canceling the at least one PUCCH repetition.

14. A method of wireless communication performed by a source base station, comprising:
transmitting, to a user equipment (UE), a configuration associated with a quantity of physical uplink control channel (PUCCH) repetitions; and
receiving, from the UE, a PUCCH repetition in each of one or more slots of a source master cell group (MCG) associated with the source base station during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions.

15. The method of claim 14, wherein the counting of the PUCCH repetitions is based, at least in part, on counting the slots of the source MCG associated with the canceled PUCCH repetitions.

16. The method of claim 14, wherein the counting of the PUCCH repetitions is based at least in part on not counting the slots of the source MCG associated with the canceled PUCCH repetitions.

17. An apparatus for wireless communication, comprising:
at least one processor; and
memory coupled to the at least one processor, the memory including code executable by the at least one processor to cause the apparatus to:
transmit, to a source base station associated with a source master cell group (MCG), a physical uplink control channel (PUCCH) repetition in each of one or more slots of the source MCG during a dual active protocol stack (DAPS)-based handover of the UE from the source MCG to a target MCG;
transmit, to a target base station associated with the target MCG, an uplink transmission in one or more slots to the target base station during the DAPS-based handover;
cancel at least one PUCCH repetition associated with the source MCG, the canceled at least one PUCCH repetition overlapping in time with the uplink transmission to the target MCG; and
perform a counting of PUCCH repetitions based, at least in part, on the cancelation of the at least one PUCCH repetition.

18. The apparatus of claim 17, wherein in order to perform the counting of the PUCCH repetitions, the memory further includes code executable by the at least one processor to cause the apparatus to count the slots of the source MCG associated with the canceled PUCCH repetitions.

19. The apparatus of claim 17, wherein in order to perform the counting of the PUCCH repetitions, the memory further includes code executable by the at least one processor to cause the apparatus not to count the slots of the source MCG associated with the canceled PUCCH repetitions.

20. The apparatus of claim 17, wherein the uplink transmission in the one or more slots of the target MCG during the DAPS-based handover is one of: a PUCCH transmission, a physical uplink shared channel (PUSCH) transmission, a sounding reference signal (SRS), a physical random access channel transmission (PRACH), a message 3 (Msg3) PUSCH transmission of a four-step random access channel (RACH) procedure, or a message (MsgA) of a two-step RACH procedure.

21. The apparatus of claim 17, wherein the DAPS-based handover is associated with a frequency division duplexing (FDD)-to-FDD handover, a time division duplexing (TDD)-to-TDD handover, a TDD-to-FDD handover, or an FDD-to-TDD handover, wherein FDD is associated with a paired spectrum and TDD is associated with an unpaired spectrum.

22. The apparatus of claim 17, wherein the PUCCH repetitions have a same time domain resource allocation in each of the one or more slots of the source MCG.

23. The apparatus of claim 17, wherein the at least one processor causes the apparatus to:
cancel the PUCCH repetitions associated with the source MCG based at least in part on a lack of UE capability for power sharing between the source MCG and the target MCG during the DAPS-based handover.

24. The apparatus of claim 17, wherein the at least one processor causes the apparatus to:
cancel the PUCCH repetitions associated with the source MCG based at least in part on a UE capability of canceling uplink transmissions during the DAPS-based handover.

25. The apparatus of claim 17, wherein the at least one processor causes the apparatus to:
cancel the PUCCH repetitions associated with the source MCG based at least in part on an intra-frequency DAPS-based handover.

26. The apparatus of claim 17, wherein:
the one or more slots of the source MCG include one or more of uplink slots or special slots; and
the one or more slots of the target MCG include one or more of uplink slots or special slots.

27. The apparatus of claim 17, wherein the at least one processor causes the apparatus to end the PUCCH repetitions and associated repetitions to the source MCG upon canceling the at least one PUCCH repetition.

28. An apparatus for wireless communication, comprising:
at least one processor; and
memory coupled to the at least one processor, the memory including code executable by the at least one processor to cause the apparatus to:
transmit, to a user equipment (UE), a configuration associated with a quantity of physical uplink control channel (PUCCH) repetitions; and
receive, from the UE, a PUCCH repetition in each of one or more slots of a source master cell group (MCG) associated with the apparatus during a dual active protocol stack (DAPS)-based handover of the UE from the source MCG to a target MCG, wherein the PUCCH repetitions that overlap in time with an uplink transmission to the target MCG are canceled and a counting of the PUCCH repetitions is based at least in part on slots of the source MCG associated with the canceled PUCCH repetitions

29. The apparatus of claim 28, wherein the counting of the PUCCH repetitions is based, at least in part, on counting the slots of the source MCG associated with the canceled PUCCH repetitions.

30. The apparatus of claim 28, wherein the counting of the PUCCH repetitions is based at least in part on not counting the slots of the source MCG associated with the canceled PUCCH repetitions.
